(19) United States
(12) Patent Application Publication
(10) Pub. No.: US 2009/0181286 A1
(43) Pub. Date: Jul. 16, 2009

(54) CELL VOLTAGE MEASURING SYSTEMS AND METHODS

(76) Inventors: DOUGLAS A. BRUNNER, Bear, DE (US); Brian W. Peticolas, Redondo Beach, CA (US)

Correspondence Address: RATNERPRESTIA, P.O. BOX 1596, WILMINGTON, DE, 19899, US

(21) Appl. No.: 12/329,903

(22) Filed: Dec. 8, 2008

Related U.S. Application Data
(60) Provisional application No. 61/012,565, filed on Dec. 10, 2007.

(51) Int. Cl. H01M 10/48; H01M 10/44

(52) U.S. Cl. 429/50; 429/92

(57) ABSTRACT

Cell voltage measuring systems and methods for determining voltage levels across cells within a string of electrochemical cells coupled to each other in series are provided. The string of electrochemical cells has a plurality of tap points dispersed throughout the string. A network of electro-mechanical relays electrically couple to the string of electrochemical cells with each relay coupling to a respective tap point. A controller is coupled to the network of relays and selectively activates a pair of relays within the network responsive to a selection signal. Activation of the pair of relays develops an output voltage level that corresponds to the voltage across one or more cells between respective tap points of the activated pair of relays.

### CROSS REFERENCE TO RELATED APPLICATIONS

This application claims the benefit of the filing date of provisional application Ser. No. 61/012,565 entitled “Cell Voltage Measuring Systems and Methods” filed Dec. 10, 2007, the contents of which are incorporated fully herein by reference.

### FEDERALLY SPONSORED RESEARCH STATEMENT

This invention was made with government support under contract number JPP-05-DE-03-7001 awarded by the Federal Transit Administration (FTA). The government may have rights in this invention.

### FIELD OF THE INVENTION

The present invention relates to electrochemical cells such as fuel cell and battery structures. More particularly, the present invention relates to systems and methods for measuring voltages within strings of electrochemical cells.

### BACKGROUND OF THE INVENTION

Cell voltage measuring systems are important diagnostic tools for electrical devices that are powered by electrochemical cells such as fuel cells or batteries. Since each individual cell produces a relatively small voltage, typical systems include groups of cells arranged together in a string. Cell voltage measuring systems can be used to determine the polarization curve (the relationship of voltage to current) for individual cells in the string of electrochemical cells. Analysis of the curves, singly or as a group, can be used to determine the health of the string of electrochemical cells or an individual cell. For example, a fuel cell which shows a linear portion of its polarization curve with a steeper slope than other cells is experiencing greater resistive loss than the other cells, which may indicate a dry cell membrane condition. Similarly, a fuel cell which experiences an increase in its downward slope of voltage relative to current before other cells is experiencing greater mass transport loss, which may indicate a degraded catalyst or delamination of catalyst layers.

Cell voltage measuring systems can be used to monitor strings of electrochemical cells such as fuel cell or battery systems for abnormally low or high cell voltages. In response to abnormally low or high cell voltages, the cell voltage measuring system may signal the need to take corrective action such as reducing current, charging or discharging a single cell, or performing battery maintenance, for example.

### SUMMARY OF THE INVENTION

In accordance with one aspect of the present invention, a cell voltage measuring system is provided for determining voltage levels across cells within a string of electrochemical cells having a plurality of cells electrically coupled in series, with the string of electrochemical cells having tap points dispersed throughout the string. A network of electro-mechanical relays electrically couples to the string of electrochemical cells with each relay coupling to a respective tap point in the string. A controller is coupled to the network of relays. The controller selectively activates a pair of relays within the network of relays responsive to a selection signal, to develop an output voltage level corresponding to the voltage level across one or more cells between the respective tap points of the activated pair of relays.

In accordance with another aspect of the invention, a method for determining voltage levels across cells within a string of electrochemical cells is provided. The method includes the step of activating a pair of electromagnetic relays corresponding to tap points within the string of electrochemical cells responsive to a selection signal. An output voltage level corresponding to the voltage across one or more cells is then developed between the respective tap points of the activated pair of relays and presented.

According to yet another aspect of the present invention, a method for scanning voltage levels of serially connected cells within a string of electrochemical cells is provided. The string of electrochemical cells includes tap points located at each end of the string and between each cell within the string of electrochemical cells. The method includes the step of scanning a first non-sequential subset of the cells within the string of electrochemical cells to obtain voltage levels for each of the cells in the first non-sequential subset. A second non-sequential subset of the cells within the string of electrochemical cells is then scanned to obtain voltage levels for each of the cells in the second non-sequential subset, the second subset different from the first subset. The one or more obtained voltage levels are subsequently presented on a display or used by a control system.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. This emphasizes that according to common practice, the various features of the drawings are not drawn to scale. On the contrary, the dimensions of the various features are arbitrarily expanded or reduced for clarity. Included in the drawings are the following figures:

FIG. 1 is a schematic diagram of a cell voltage measuring system that measures voltage levels across cells within a string of electrochemical cells in accordance with aspects of the invention;

FIG. 2 is a flow chart of exemplary steps for measuring cell voltage in accordance with aspects of the invention; and

FIG. 3 is a flow chart of exemplary steps for scanning cells in accordance with an embodiment of the invention.

### DETAILED DESCRIPTION OF THE INVENTION

The invention will next be described with reference to the figures. Such figures are intended to be illustrative rather than limiting and are included herewith to facilitate the explanation of the present invention.

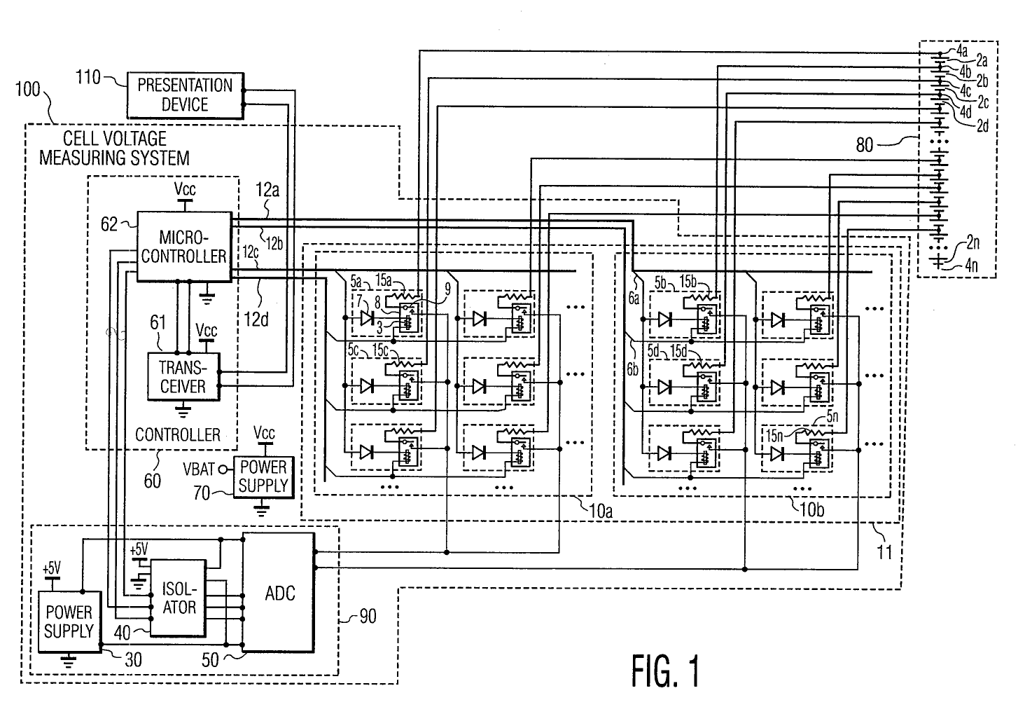

Referring generally to the drawings (FIGS. 1-3), in accordance with an exemplary embodiment, an exemplary cell voltage measuring system 100 for determining voltage levels across cells 2a-n within a string of electrochemical cells 80 is provided. The string of electrochemical cells 80 may be a fuel cell stack or battery, for example. Cells 2 are electrically coupled in series and tap points 4a-n are dispersed throughout the string of electrochemical cells 80, e.g., between each cell 2. A network of electromechanical relays 11 is electrically coupled to the string of electrochemical cells 80 and is divided into relay banks 10a, b. The relay banks 10 include a plurality of electromechanical relays 5a-n, which are coupled to respective tap point 4. A controller 60 is coupled to the relay network 11 and selectively activates relay pairs responsive to a selection signal. Activation of a pair of relays 5 produces an output voltage level corresponding to the voltage across the one or more cells 2 between respective tap points 4 of the activated pair of relays 5.

Referring now to the individual drawings in detail, FIG. 1 depicts a schematic view of an exemplary cell voltage measuring system 100 for determining voltage levels across cells within a string of electrochemical cells 80 having a plurality of cells 2a-n connected in series in accordance with an aspect of the present invention. Tap points 4a-n dispersed throughout the string of electrochemical cells 80, e.g., at each end of the string 80 and between each of the cells 2. For example, in an exemplary embodiment, tap point 4a is coupled to the positive terminal of cell 2a, tap point 4b is connected to the negative terminal of cell 2a and the positive terminal of cell 2b, and tap point 4c is connected to the negative terminal of cell 2b and the positive terminal of cell 2c.

System 100 includes a network of electro-mechanical relays 11 is electrically coupled to tap points 4 of the string of electrochemical cells 80. In the embodiment illustrated in FIG. 1, relay network 11 includes two relay banks 10a, b that include a plurality of relay assemblies 5a-n. Relay assemblies 5 of network 11 are coupled to respective tap points 4 of the string of electrochemical cells 80 such that activation of a pair of relay assemblies 5a-n allows voltage level measurement of cells 2 between respective tap points 4a-n. For example, when relay assemblies 5a and 5b are activated, an output voltage between tap points 4a and 4b can be measured for cell 2a. In another example, when relays 5a and 5d are activated, an output voltage between tap points 4a and 4d can be measured for cells 2a-c.

In an exemplary embodiment, electromechanical relay assemblies 5 in network 11 are arranged in a grid within each relay bank 10a, b. According to the embodiment illustrated, each electromechanical relay assembly 5 includes a diode 7 and an electro-mechanical relay 8. In an exemplary embodiment, electro-mechanical relay 8 includes a coil 3 and switch 9. Diode 7 is connected in series with the coil 3 of relay 8. Current applied to relay 8, e.g., through diode 7, creates a magnetic field to close switch 9.

In the illustrated embodiment, cell voltage measuring system 100 also includes a controller 60 for selectively activating pairs of relays 5. Controller 60 includes a transceiver (TX/RX) 61 and microcontroller 62 that are each powered by power supply 70. A suitable microcontroller 62 is a high performance microcontroller such as part number PIC18F6585, manufactured by Microchip Technology of Chandler, Ariz., USA. In an exemplary embodiment, microcontroller 62 receives commands from transceiver 61 to read voltage across one or more cells 2. A suitable transceiver 61 is a two line input/output transceiver, such as part number MAX202, manufactured by Maxim Integrated Products of Sunnyvale, Calif., USA. A presentation device 110 (e.g., a display, speaker, printer, etc.) may present information received from the controller 62 such as the voltage level across the cells 2 being read. Additionally, controller 60 or other cell controller (not shown) may take necessary action to correct improper cell voltages. Suitable microcontrollers 62, transceivers 61, presentation devices 110, and cell controllers will be understood by one of skill in the art from the description herein.

The illustrated controller 60 is coupled to each of the relay assemblies 5 via multi-line buses 12a-d. Multi-line bus 12a is connected to “column” conductors within bank 10b. Multi-line bus 12b is connected to “row” conductors within bank 10b. Similarly, multi-line bus 12c and 12d are connected to “column” and “row” conductors, respectively, within bank 10a. Individual lines of the buses 12a-d are separated from the bus (i.e., bus taps, which are represented by enumerated bus taps 6a, b) for electrical connection with individual relay assemblies 5.

In the illustrated embodiment, each diode 7 of a relay assembly 5 is connected to a common “column” conductor within a bank 10 and each coil 3 of a relay 8 is connected to a common “row” conductor within a bank 10. In an exemplary embodiment, to activate a relay assembly 5 in network 11, bus taps 6 are used to supply a voltage differential across diode 7 and coil 3 of relay 8 of a particular relay assembly 5. For example, to activate relay assembly 5b, logic high voltage (e.g., +5 volts) is applied to the “column” conductor connected to bus tap 6a and logic low voltage (e.g., 0 volt) is applied to the “row” conductor connected to bus tap 6b. The voltage differential between bus taps 6a, b causes diode 7 to drive current into the coil 3 of relay 8, thereby generating a magnetic field that actuates switch 9 of the relay 8 such that the contact pins are electrically connected. In an exemplary embodiment, high voltage may be applied to “row” conductors, and low voltage may be applied to “column” conductors to prevent current flow through the coil 3 of relay 8 by reverse biasing the diode 7 and deactivate relay assembly 5. Alternatively, cessation of voltage through both “column” and “row” conductors may deactivate relays 5a-n. Other suitable electromechanical relays and techniques for actuating them will be understood by one of skill in the art from the description herein.

In the illustrated embodiment, each relay assembly 5 also includes a resistor 15a-n connected in series with a respective tap point 4. Connecting a resistor 15 to each relay 5 in network 11 provides protection against overcurrent, e.g., due to a fault. In an exemplary embodiment, activation of a pair of relay assemblies 5 electrically couples at least two resistors 15 in series with the cells 2a-c to be measured. When the resistors 15 are connected in series to a cell 2, individual resistances are added together thereby providing protection against electrical faults and minimizing the possibility of damage to cells 2. Furthermore, in the event of a “stuck” relay 8 that causes three relays 8 to be activated at the same time, the possibility of a short circuit is minimized.

Additionally, a cell voltage measuring system 100 having electromechanical relays 8 rather than semiconductor switches (not shown) minimizes leakage current flowing through deactivated switching elements. By reducing this leakage current and the associated resistive voltage drop through interconnects and fault protection resistors, more accurate monitoring of voltage levels may be achieved. System 100 may also achieve better measurement accuracy compared to other systems using resistive voltage dividers because the full voltage of each cell 2 is measured, thereby reducing the effect of calibration drift on accuracy.

Cell voltage measuring system 100 further includes an isolator 90 electrically coupled to each relay assembly 5. When a pair of relay assemblies 5 is activated, isolator 90 receives an analog voltage signal from a selected cell 2. In the illustrated embodiment, isolator 90 includes an analog-to-digital converter (ADC) 50, a digital isolator 40, and a power supply 30. Suitable ADCs 50, digital isolators 40, and power supplies 30 will be understood by one of skill in the art from the description herein.

ADC 50 receives analog voltage signals from a selected cell 2 and converts the analog signal to a digital signal. In the illustrated embodiment, ADC 50 then transmits the digital signal to digital isolator 40 where the digital signal corresponding to the measured voltage is isolated and transmitted as a bit code to microcontroller 62. In an alternative embodiment, ADC 50 transmits the digital signal directly to controller 60. According to an embodiment, once a pair of relay assemblies 5 is activated, microcontroller 62 waits a prescribed settling time (usually 50 milliseconds or less) to allow the ADC 50 to stabilize before reading the voltage through digital isolator 40.

In another embodiment, instead of separate ADC 50 and digital isolator 40 chips, an analog isolator unit (not shown) and a microcontroller 62 with an integral ADC may be used. Alternatively, the control circuits actuating the relay assemblies 5 can be implemented with discrete logic chips. Other suitable circuit components that convert analog signals to digital signals will be understood by one of skill in the art from the description herein.

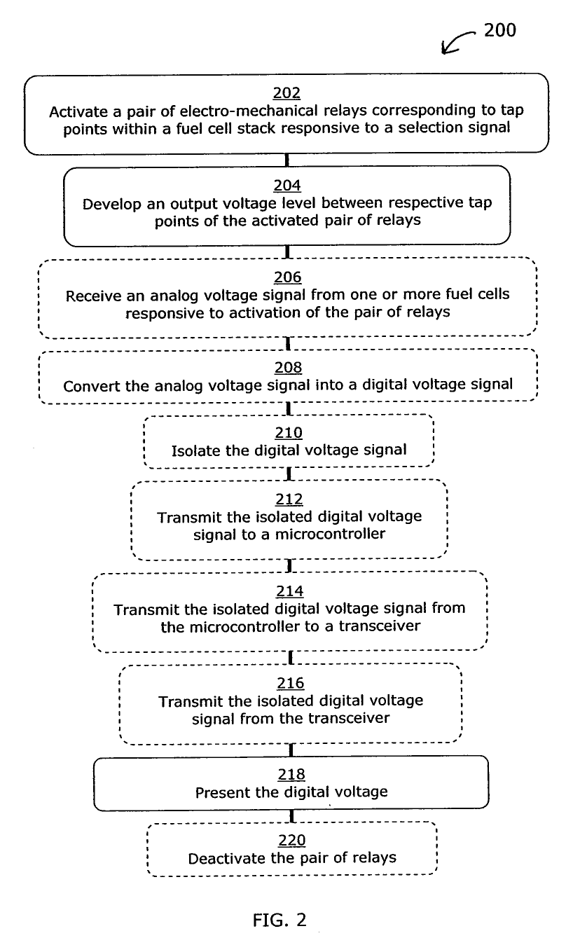

Referring now to FIG. 2, a sequence of exemplary steps 200 is illustrated for measuring voltages of cells 2 in a string of electrochemical cells 80 such as a fuel cell stack or battery. The steps are described with reference to FIG. 1.

At step 202, a pair of electromechanical relay assemblies 5 corresponding to tap points 4 within the string of electrochemical cells 80 is activated responsive to a selection signal. The selection signal, for example, may be received by a transceiver 61 and then transmitted to microcontroller 62 to control the activation/deactivation of relay assemblies 5. In an exemplary embodiment, a pair of relay assemblies 5 may be activated in a predetermined order to measure individual cell voltage in the string of electrochemical cells 80.

According to an exemplary embodiment, responsive to a selection signal from transceiver 61, microcontroller 62 first deactivates all relay assemblies 5 and then waits a prescribed period (e.g., 1 millisecond) for switches 9 of relays 8 to disengage. After switches 9 are disengaged, one relay assembly 5 is activated at a time for a selected cell 2. For example, to measure voltage across cell 2a, relay assemblies 5a and 5b are activated. Relay assemblies 5a and 5b then are deactivated and relay assemblies 5b and 5c are activated to subsequently measure voltage across cell 2b.

At step 204, an output voltage level is developed between respective tap points 4 of the activated pair of relay assemblies 5. At step 206, an analog voltage signal is received from one or more cells 2 responsive to the activation of the pair of relays. At step 208, the analog voltage signal is converted into a digital voltage signal. The analog voltage signal may be converted using analog-to-digital converter 50 (ADC).

Optionally, at step 210, the digital voltage signal is conveyed by a digital isolator 40. The digital isolator 40 may isolate the signal in a bit code that is readable by microcontroller 62. At step 212, the voltage signal is transmitted to microcontroller 62. In an exemplary embodiment, waiting a prescribed settling time (usually 50 milliseconds or less) allows ADC 50 to stabilize before reading the voltage through digital isolator 40.

At step 214, microcontroller 62 transmits the digital voltage signal to transceiver 61 so the signal may be transmitted, at step 216, from the transceiver 61, e.g., to presentation device 110 or a storage device (not shown). At step 218, the digital voltage signal is presented, e.g., on a presentation device 110. The signal may be transmitted wirelessly or by a direct electrical connection. The pair of relay assemblies 5 are then deactivated at step 220.

Steps 202-218 may be repeated as needed to measure voltages of the other cells 2 in the string of electrochemical cells 80.

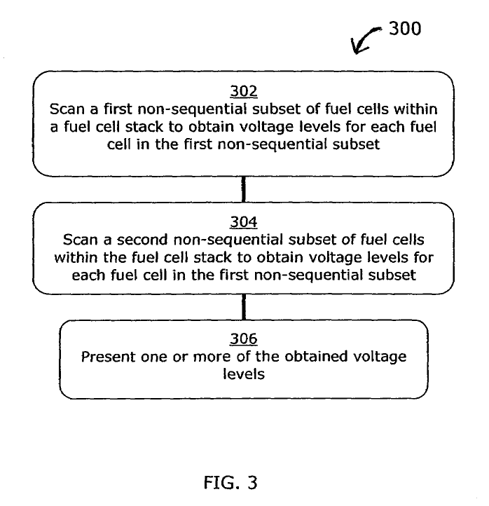

Referring now to FIG. 3, a sequence of exemplary steps 300 is illustrated for scanning cells 2 in a string of electrochemical cells 80.

At step 302, a first non-sequential subset of cells 2 is scanned to obtain voltage levels for the cells in the first non-sequential subset and, then, at step 304, a second non-sequential subset of cells 2 is scanned to obtain voltage levels for the cells in the second non-sequential subset. The first non-sequential subset may correspond to odd-numbered cells in the string of electrochemical cells 80 (e.g., cells 2a, 2c, etc.) and the second non-sequential subset may correspond to even-numbered cells 2 in the string of electrochemical cells 80 (e.g., cells 2b, 2d, etc.), or vice versa. The first non-sequential subset may have voltage levels of a first polarity (e.g., positive voltages) with respect to ADC 50 and the second non-sequential subset may have voltage levels of a second polarity different from the first polarity (e.g., negative voltages) with respect to ADC 50. Although this aspect of the invention is described using two subsets, it is to be understood that the cells may be divided into more than two subsets.

According to an exemplary embodiment, system 100 measures the voltage level of each cell 2 according to a scanning pattern that scans all cells within the first non-sequential subset followed by all cells within the second non-sequential subset. In a string of ten cells connected in series and numbered consecutively from one to ten, for example, the order of measuring the voltage levels of cells may be cells 1, 3, 5, 7, 9 followed by cells 2, 4, 6, 8, 10.

Including only cells of the same polarity with respect to ADC 50 within a particular subset (e.g., all positive or all negative for cells in good working order) allows ADC 50 to settle relatively quickly when system 100 is scanning through the cells of that subset due to relatively small voltage level changes when transitioning from one cell to the next within that subset. In contrast, scanning adjacent cells 2 in sequence would require additional time for ADC 50 to settle due to the relatively large voltage swings applied to ADC 50 (e.g., from a positive voltage level to a negative voltage level, or vice versa) when transitioning from one cell to the next adjacent cell.

At step 306, one or more of the obtained voltage levels is presented on display 110 and/or stored. The obtained voltage levels may be presented and/or stored as each cell 2 is scanned, intermittently during scanning, or after all cells 2 have been scanned.

Although the present invention has been particularly described in conjunction with specific embodiments, many alternatives, modifications, and variations will be apparent to those skilled in the art from the description herein. It is therefore contemplated that the appended claims will embrace any such alternatives, modifications, and variations as falling within the true scope and spirit of the present invention.

What is claimed:

1. A cell voltage measuring system for determining voltage levels across cells within a string of electrochemical cells having a plurality of cells electrically coupled in series, the string of electrochemical cells having a plurality of tap points dispersed throughout the string, the system comprising:
a network of electromechanical relays that electrically couple to the string of electrochemical cells, each relay coupling to a respective tap point in the string; and
a controller coupled to the network of relays, the controller selectively activating a pair of relays within the network of relays responsive to a selection signal to develop an output voltage level corresponding to the voltage level across one or more cells between the respective tap points of the activated pair of relays.

2. The system of claim 1, wherein each tap point is electrically coupled to a resistor such that activation of the pair of relays electrically couples at least two resistors in series with the one or more cells.

3. The system of claim 1, wherein the controller comprises a transceiver for receiving the selection signal to read voltages from the one or more cells.

4. The system of claim 3, wherein the controller further comprises a microcontroller for selectively activating the pair of relays responsive to the selection signal.

5. The system of claim 1, further comprising an isolator electrically coupled to each relay, the isolator configured receive an analog voltage signal from the one or more cells responsive to activation of the pair of relays.

6. The system of claim 5, wherein the isolator comprises an analog-to-digital converter (ADC) for receiving the analog voltage signal and converting the analog voltage signal into a digital voltage signal.

7. The system of claim 6, wherein the isolator further comprises a digital isolator for receiving and isolating the digital voltage signal from the analog-to-digital converter (ADC).

8. The system of claim 7, wherein the isolator further comprises an isolated power supply for powering the analog-to-digital converter (ADC) and the digital isolator.

9. A method for determining voltage levels across cells within a string of electrochemical cells, the method comprising the steps of:
activating a pair of electro-mechanical relays corresponding to tap points within the string of electrochemical cells responsive to a selection signal;
developing an output voltage level corresponding to the voltage across one or more cells between the respective tap points of the activated pair of relays; and
presenting the output voltage level.

10. The method of claim 9, further comprising receiving an analog voltage signal from the one or more cells responsive to activation of the pair of relays.

11. The method of claim 10, further comprising converting the analog voltage signal into a digital voltage signal.

12. The method of claim 11, further comprising the step of isolating the digital voltage signal.

13. The method of claim 12, further comprising the step of transmitting the isolated digital voltage signal to a microcontroller.

14. The method of claim 13, further comprising the step of transmitting the isolated digital voltage signal from the microcontroller to a transceiver.

15. The method of claim 14, further comprising the step of transmitting the isolated digital voltage signal from the transceiver.

16. The method of claim 9, wherein the presenting step comprises displaying the output voltage level on a display.

17. A method for scanning voltage levels of serially connected cells within a string of electrochemical cells, the string of electrochemical cells including tap points located at each end of the string and between each cell within the string of electrochemical cells, the method comprising the steps of:
scanning a first non-sequential subset of the cells within the string of electrochemical cells to obtain voltage levels for each of the cells in the first non-sequential subset;
scanning a second non-sequential subset of the cells within the string of electrochemical cells to obtain voltage levels for each of the cells in the second non-sequential subset, the second subset different than the first subset; and
presenting one or more of the obtained voltage levels.

18. The method of claim 17, wherein the scanning of the first non-sequential subset of cells within the string of electrochemical cells obtains voltage levels of a first polarity.

19. The method of claim 18, wherein the scanning of the second non-sequential subset of cells within the string of electrochemical cells obtains voltage levels of a second polarity that is opposite the first polarity.

20. The method of claim 17, wherein either the first or the second non-sequential subset comprises odd numbered cells within the string of electrochemical cells.

21. The method of claim 20, wherein the other non-sequential subset comprises even numbered cells within the string of electrochemical cells.
